(19) United States
(12) Patent Application Publication
(10) Pub. No.: US 2007/0137481 A1
(43) Pub. Date: Jun. 21, 2007

(54) METHOD TO MEASURE OLEFINS IN A COMPLEX HYDROCARBON MIXTURE

(76) Inventors: Jan Blomberg, Amsterdam (NL); Xander Dupain, Delft (NL); Michiel Makkee, Delft (NL); Jacob Adriaan Moulijn, Delft (NL); Colin John Schaverien, Amsterdam (NL)

Correspondence Address: SHELL OIL COMPANY, P O BOX 2463, HOUSTON, TX, 772522463, US

(21) Appl. No.: 11/612,220

(22) Filed: Dec. 18, 2006

(30) Foreign Application Priority Data
Dec. 20, 2005 (EP) 05112442.8

(51) Int. Cl. G01N 30/02

(52) U.S. Cl. 95/82; 73/19.02

(57) ABSTRACT

A method to measure the quantity of olefin species in a complex hydrocarbon mixture by means of comprehensive multi-dimensional gas chromatography, involves passing a sample of a hydrocarbon mixture through a first capillary column comprising a dimethyl-polysiloxane stationary phase, subjecting the sample to a thermal modulation before entering a second column comprising a 50% phenyl, equivalent, polysilphenylene-siloxane stationary phase, wherein the introduction bandwidth into the second column is smaller than 20 milliseconds.

### CROSS-REFERENCE TO RELATED APPLICATION

This application claims the benefit of European Patent Application No. 05112442.8, filed Dec. 20, 2005, which is incorporated herein by reference.

### FIELD OF THE INVENTION

The invention is directed to a method to measure the quantity of olefin species in a complex hydrocarbon mixture by means of comprehensive multi-dimensional gas chromatography.

### BACKGROUND OF THE INVENTION

Comprehensive two-dimensional gas chromatography (GCxGC) as an analytical method is well known and for example described in J. Blomberg, J. Beens, P. J. Schoenmakers, R. Tijssen, J. High Resol. Chromatogr., 20 (1997) p. 125 and in P. J. Schoenmakers, J. L. M. M. Oomen, J. Blomberg, W. Genuit, G. van Velzen, J. Chromatogr. A, 892 (2000) p. 29 and further.

A disadvantage of the method described in J. Blomberg, J. Beens, P. J. Schoenmakers, R. Tijssen, J. High Resol. Chromatogr., 20 (1997) p. 539-544 is that the signals of the mono-naphthenic compounds coincided with those of the paraffin and that only limited information could be obtained on olefin compounds. Furthermore, the contemporary GCxGC equipment limited the application range to samples, which comprise compounds boiling below 350° C.

### SUMMARY OF THE INVENTION

The present invention provides a method to measure olefin compounds in hydrocarbon mixtures comprising compounds boiling above 350° C. In a preferred embodiment, the invention provides a method to measure the quantity of olefin species in a complex hydrocarbon mixture by means of comprehensive multi-dimensional gas chromatography, wherein a sample of the hydrocarbon mixture first passes a first capillary column comprising a dimethyl-polysiloxane stationary phase, the sample further subjected to a thermal modulation before entering a second column comprising a 50% phenyl, equivalent, polysilphenylene-siloxane stationary phase, wherein the introduction bandwidth into the second column is smaller than 20 milliseconds.

### BRIEF DESCRIPTION OF THE DRAWINGS

FIGS. 1a-1c are simulated-distillation chromatograms of a FT-LF feed and products.

FIGS. 2a and 2b are GCxGC chromatograms of the FT-LF feed and products of Example 1.

FIGS. 3a and 3b are enlarged, highlighted portions of FIGS. 2a and 2b.

FIGS. 4a-4f are graphs of the quantitative results of the GCxGC analyses of Example 1.

FIGS. 5a and 5b are graphs of the measurements of i-olefins, mono-aromatics and di-aromatics of Example 1.

FIGS. 6a-6d are graphs of the quantitative data of the PIONA analyses of Example 1.

### DETAILED DESCRIPTION OF THE INVENTION

Applicants found that by using the specific combination of first and second columns and a certain low introduction bandwidth it became possible to quantify olefins in a complex hydrocarbon mixture. Being able to quantify olefins in such higher boiling hydrocarbon mixtures opens a wide range of applications, which are also part of the present invention.

The first column is a capillary column having a dimethyl-polysiloxane stationary phase. In this technical field the stationary phase is also referred to as pure dimethyl-polysiloxane. The length of the first column is preferably between 5 and 50 m, more preferably between 8 and 12 m, the diameter of the first column is preferably between 0.1 and 0.6 mm, more preferably between 0.2 and 0.3 mm and the thickness of the stationary phase is preferably between 0.05 and 3 um. Such first capillary columns are commercially available, for example as DB-1 from J&W Scientific, Folsom, Calif., USA.

The second capillary column has a 50% phenyl (equivalent) polysilphenylene-siloxane as the stationary phase. The term equivalent refers to the fact that phenyl groups form part of the backbone of the siloxane polymer. This stationary phase is well known and columns containing said phase are, for example, the BPX50 as obtainable from SGE, Ringwood, Australia. The length of the second column is preferably between 0.5 and 4 m, the diameter of the second column is preferably between 0.08 and 0.6 mm and the thickness of the stationary phase is preferably between 0.05 and 3 um.

The dimensions of the first and second columns are furthermore preferably so chosen that the phase ratio in the first and/or the second column is between 100 and 500, wherein the phase ratio is calculated by the following formula:
phase ratio=R/(2*Df), (1)
wherein R is the radius of the column and Df is the thickness of the stationary phase.

The introduction bandwidth into the second column is smaller than 20, preferably smaller than 15 milliseconds and even more preferably between 8 and 12 milliseconds. Such low bandwidth values are technically achievable by using a so-called jet-based cryogenic thermal modulation. The modulation process comprises alternating trapping and releasing compounds from the downstream part of the first column. The principle and apparatus for performing such a thermal modulation is for example described in WO-A-9213622. In this patent publication a moving heat source runs along a section of column release accumulated compounds into the second column. More preferably modulation is being achieved by means of alternating cooling and heating. Preferably such thermal modulation is performed making use of a so-called cryogenic modulator or a two-jet cryogenic modulator as for example described in US2001/0037727, WO-A-01/51179 and US-A-2005/0139076. Other possible modulators and apparatuses to perform the comprehensive multi-dimensional gas chromatography according to the present invention are described in US-A-2003/0100124 and in US-A-2005/0106743.

The complex hydrocarbon mixture may comprise iso- and normal paraffins, mono-napthenic, 2-ring and higher naphthenic compounds, olefins, aromatics and even oxygenated species of the afore-mentioned hydrocarbons. The complex mixture will preferably boil for more than 90 wt %, more preferably for more than 95 wt %, between 100 and 575° C. and comprises preferably more than 10 wt %, more preferably more than 20 wt % of components boiling between 350 and 575° C. Examples of such complex hydrocarbon mixtures are refinery fractions, such as fractions obtained in the vacuum distillation of a crude petroleum source, the effluent of refinery conversion processes such as catalytic cracking, fluid catalytic cracking (FCC), thermal cracking, vis-breaking, hydrocracking, hydroisomerization and catalytic dewaxing and feeds to said processes. Other complex mixtures include the synthesis product of a Fischer-Tropsch synthesis and the effluent of a hydrocracking, hydroisomerization, hydrogenation, thermal cracking, vis-breaking and fluid catalytic cracking process of such a synthesis product.

In the preferred method according to the invention a sample is submitted to a suitable comprehensive multi-dimensional gas chromatography set-up, also referred to as GCxGC, equipped with a dual-stage cryogenic modulator. In the first column the sample is separated into its components according to their different vapour pressures. The eluting partly separated molecules from this first column are accumulated and concentrated by the thermal modulation to form small packages of molecules which are subsequently released at frequent intervals into the second-dimension column. Since the separation in the second column is much faster than the separation in the first column, several second-dimension separations can be developed over a single separation of the first dimension. As a consequence, the separation performed by the first column can essentially be maintained. Separation of the sample on independent (orthogonal) component properties (volatility and polarity), results in an ordered separation and effective use of the high peak capacity of the two-dimensional space. The sample elutes entirely and information on a molecular level can be obtained over a large boiling-range.

The results of comprehensive multi-dimensional gas chromatograms are usually presented as false-colour plots in which full-range bands of the different hydrocarbon group-types appear. The band with the paraffins has the lowest second dimension retention times since it possesses the lowest polarity, followed by the bands of olefins and naphthenes at higher retention times. At even higher second dimension retention times alcohols and aromatics are located. Every band can be divided up in ‘tiles’ that represent the hydrocarbon group of a given carbon number (isomers). Within each tile, there is an ordering based on the branching of the alkyl-substitutents. For instance, the highly branched paraffins are located most left in the tile, whereas the linear paraffins are located most right. Since increased branching apparently also leads to a reduced polarity, a tile displays a certain inclination in the chromatogram. As a result, different tiles are stacked in the increasing direction of the first dimension, commonly denoted as ‘roof-tiling’. In principle, this roof-tiling prevents the signal of paraffins of given carbon number from interfering with the paraffins of a lower or higher carbon number, something which is inevitable in the case for simulated distillation. In practice some overlap between paraffins with different carbon numbers can occur, complicating the interpretation of the chromatogram mainly because the inclination of the tiles is somewhat different, e.g. a paraffin tile can overlap with an olefin tile. In addition, full separation in the first column of the peaks in the C₅-C₈ range can be difficult to obtain.

The resolution between linear and mono-methyl branched species is better than the resolution between subsequent branched species in a tile (e.g. between the methyl-branched members and di-methyl-branched members). The intensity profile along a roof-tile provides a very good impression of the degree of branching. In the prior art GCxGC methods the olefin peaks overlapped with the naphthenic compounds. By performing the GCxGC according the invention the olefin peaks did not overlap with the naphthenic compound peaks making it possible to quantify both olefins and naphthenic compounds.

Applicants have found that olefins as present in the reaction product of a fluid catalytic cracking process can advantageously be quantified. The level of information thus obtained even makes it possible to develop a kinetic model of the reactions occurring in the catalytic cracking process. Preferably the information provided by the GCxGC method is used in combination with the analytical results obtained by the so-called and well-known PIONA analysis.

PIONA analysis is a standardized gas-chromatographic technique to determine n-paraffins, i-paraffins, n-olefins, i-olefins, c-olefins, naphthenes, and aromatics (PIONA) in a liquid hydrocarbon mixture. Its principle of operation is based on a number of smart ‘trapping’ events of groups of hydrocarbons with similar properties followed by the separations on columns with different characteristics. The main restriction is that the PIONA method is limited to data on hydrocarbons with boiling points up to 200° C. only. This corresponds for the FT-LF with a carbon number of approximately C₁₁. A major advantage, however, is that the separation in the C₅-C₁₁ range is significantly better than that obtained by the GCxGC approach.

The analytical methods yield highly detailed data on the mechanistic aspects in conversion and formation of the reactants and products in a catalytic cracking process, which is valuable to operation optimisation and catalyst development of processes based on catalytic cracking. The invention is therefore also directed to a method to make a kinetic model of the catalytic cracking reactions by subjecting a well defined feed to a catalytic cracking reaction at a well defined temperature and catalyst concentrations, measuring the reactants at different catalyst contact times with the method according to the present invention, calculating the kinetic constants for the possible reactions and obtaining a kinetic model. The kinetic model is suitable to predict the reaction products of a catalytic cracking process and for that reason the invention is also directed to the use of said model to control a catalytic cracking process and a fluid catalytic cracking process (FCC) in particular.

One of the strengths of the Fluid Catalytic Cracking (FCC) process is the selective production of high-octane gasoline from heavy oil fractions. Aromatics, naphthenes, and branched species that are formed during the process possess relatively high octane numbers. The reaction mechanisms for catalytic cracking in general have been a topic that has been studied for many years both because of the practical importance and scientific curiosity. Oil fractions contain thousands of different species and the complexity of countless parallel and serial reactions during conversion processes complicates the elucidation of mechanistic aspects. In an attempt to overcome this problem much research has been focused on the catalytic cracking of model components, so that the number of feed and product components remained limited. However, translation of the results of these studies to the practical process involving a complex feed leads to ambiguous conclusions due to the large interactions that might occur between different classes of molecules. Applicants now found that by using GCxGC as described above many of the problems of the prior art methods are overcome.

Applicants also found that by building the kinetic method on experiments involving catalytic cracking of a Fischer-Tropsch Synthesis wax, a good compromise is found between simple model compounds and complex hydrocarbon mixtures. The well-defined character of this highly paraffinic feed makes it a nearly ideal feedstock for getting useful information on a molecular level. Moreover, Fischer-Tropsch waxes exhibit a high reactivity and can be converted to a high extent (>90 wt %) under normal FCC conditions.

The invention is also directed to the more general use of the analytical method to measure the olefin content in a feed and/or product of a chemical conversion process and control said chemical conversion process using the olefin content measured. A preferred chemical conversion process is a hydroprocessing treatment, suitably hydrogenation, hydroisomerization and/or hydrocracking, of an olefin containing Fischer-Tropsch derived feed.

The below example will illustrate the practical applicability of the claimed method.

### EXAMPLE

A Fischer-Tropsch Light Fraction (FT-LF) has been cracked with a commercial equilibrium catalyst (E-cat) in a laboratory-scale once-through microriser reactor. The reactor temperature has been set at 525° C. and a catalyst-to-oil ratio (CTO) of 4 g_{catalyts}·gₒᵢₗ⁻¹ has been applied. The reactor length has been varied from 0.2 m to 21.2 m, which corresponds to a residence time from 50 ms to 5 s.

The gaseous products from the cracking experiments have been analysed with a gas chromatograph equipped with a flame ionisation detector (FID) and thermal conductivity detector (TCD). Detailed information has been obtained on the amount of hydrogen and C₁-C₄ hydrocarbons. The entrained liquid fraction has been lumped in a C₅ and C₆ group. The liquid samples have been analysed according to ASTM D2887 Simulated Distillation and the obtained ‘one-dimensional’ chromatograms have been corrected for the liquid recovery. Gasoline has been defined as the C₅-215° C. product range. Light Cycle Oil (LCO), an important diesel-blending component, has a boiling range of 215-325° C. Species with a boiling point higher than 325° C. belong to the Heavy Cycle Oil (HCO) fraction.

The samples were analyzed using an Agilent 6890 GC as obtained from Agilent Technologies, Wilmington, Del., USA. The system was retrofitted with a Zeox KT2004 LN2 cryogenic thermal modulator and equipped with a second dimension-column oven (ZOEX Corporation, Lincoln, Nebr., USA), enabling independent second-dimension column heating. The column set consisted of a 10 m length×250 μm internal diameter×0.25 μm film thickness DB-1 column in the first dimension and a 2 m length 0.1 mm internal diameter×0.1 μm film thickness BPX50 column in the second dimension. The modulation was performed in a 1.6 m×0.1 mm diphenyltetramethyl-disilazane (DPTMDS) deactivated fused silica capillary as obtained from BGB Analytik, Anwil Switzerland. A fused silica capillary of the same material with a length of 50 cm was used to connect the second dimension column to the flame-ionization detector (FID). Columns were coupled with custom-made press fits. The carrier gas was helium at a constant head pressure of 250 kPa, resulting in a column flow of about 1 mL/min at 40° C.

The temperature for the first dimension column oven was programmed from 40° C. (5 minutes isothermal), followed by a ramp of 2° C./min to 300° C. (20 minutes isothermal), followed by a negative ramp of 13° C./min to 40° C. (10 minutes isothermal). Both the hot pulse of the release jet and the secondary oven were operated at an offset of 50° C. above the temperature of the primary oven.

The modulation time was 7.5 s and the hot pulse duration was 400 ms. Liquid nitrogen cooled nitrogen gas was used as modulating agent at a flow of 17 L/min. The analyses of the liquid product with GCxGC and PIONA are discussed in the following paragraphs. The amount of coke on the catalyst has been determined with a LECO C-400 carbon analyser. Detailed information about the equipment, operational- and experimental procedure is described in X. Dupain, L. J. Rogier, E. D. Gamas, M. Makkee, and J. A. Moulijn, Appl. Catal. A. 238, 223-238 (2003).

The detailed information as obtained above allows a rough ranking of the different reactivities of the hydrocarbons, using a simple first-order model:

$$\frac{ⅆ {y}_{i}}{ⅆ τ} = - {k}_{i} \cdot {y}_{i} ⇔ {y}_{i , τ 2} = {y}_{i , τ 1} \cdot exp [ - {k}_{i} \cdot ( {τ}_{2} - {τ}_{1} ) ] \qquad ( 2 )$$

wherein kᵢ is the reaction rate constant for component i in [1/s]
yᵢ=component i
τ=residence time in [s]
y_{i,τ2}=yi,τ1*exp [−kᵢ*(τ₂−τ₁)].
   means:

component i at time interval τ2=component i at time interval τ₁*exp [−kᵢ*(time difference between τ₂ and τ₁)].

Through minimisation of the squared residuals sums the value of the parameter kᵢ can be estimated. The confidence intervals have not been reported, since only a rough estimation is made. In FCC molecules many serial- and parallel reactions of components take place, i.e. every component can be formed through a range of reactions from different molecules and can also be converted through a range of reactions. The calculated reaction rate constants are thus net values.

The results of the simulated distillation, GCxGC, and PIONA analysis have been mutually validated. The hydrocarbon profiles obtained were, both qualitatively and quantitatively, similar for the three different techniques applied. Also the data from the gas analysis has been evaluated; the gas-entrained C₅ and C₆ lumps have been added up to the liquid fraction of the PIONA, where the assumption has been made that the C₅ and C₆ lumps had the same distribution as reported by PIONA.

Results

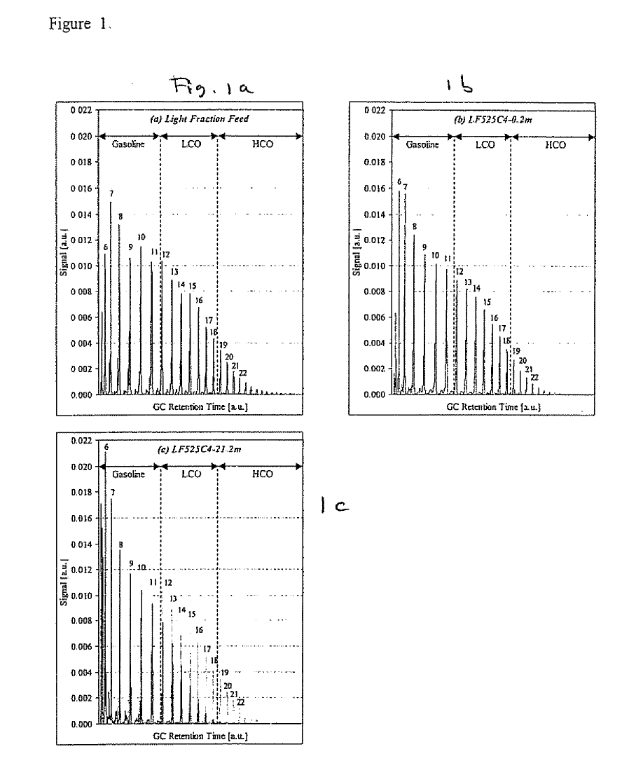

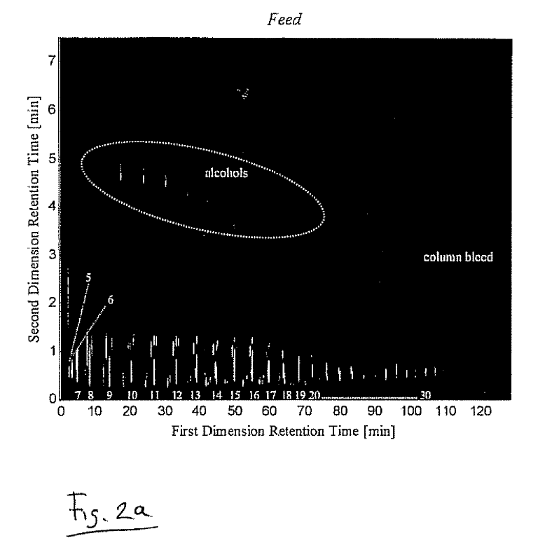

In FIG. 1 the simulated-distillation chromatograms of the FT-LF feed (FIG. 1a) and cracking products at 0.2 m (FIG. 1b) and 21.2 m (FIG. 1c) are shown. The n-paraffins in the feed, that represent about 90 wt %, are distinctly present and the peaks are well-resolved. Just in advance of each n-paraffin peak the corresponding n-olefin peak is located. The n-olefins represent about 10 wt % of the feed and are most clearly visible in the C₇-C₁l range. Some peak overlap between n-olefins and n-paraffins is observed. In advance of the n-olefins the i-paraffins, that are formed as by-product of Fischer-Tropsch Synthesis, are observed in small quantities. The separation of these species from the matrix is relatively poor. Comparison of the distributions at 0.2 and 21.2 m with the feed composition gives a wealth of information on the reactivity and product yields of the individual paraffins and olefins present. At 0.2 m (50 ms) the n-olefins have been fully converted and products in the C₅-C₈ range evolve. The remainder of the chromatogram has been rather unchanged. At 21.2 m the largest n-paraffins have been converted, and the products in the C₅-C₈ range have become even more distinctly present.

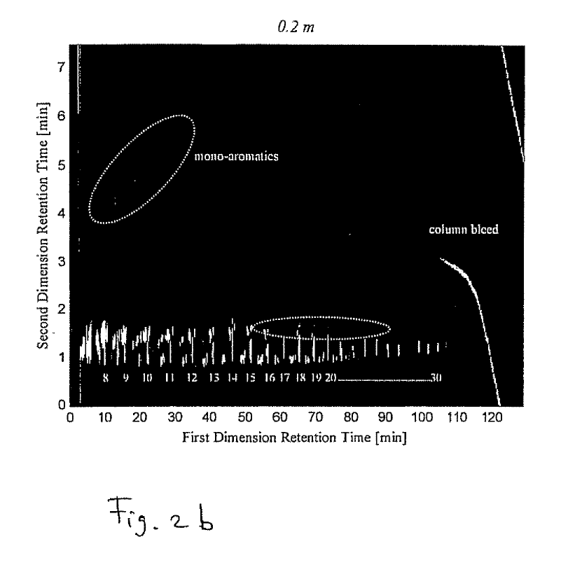

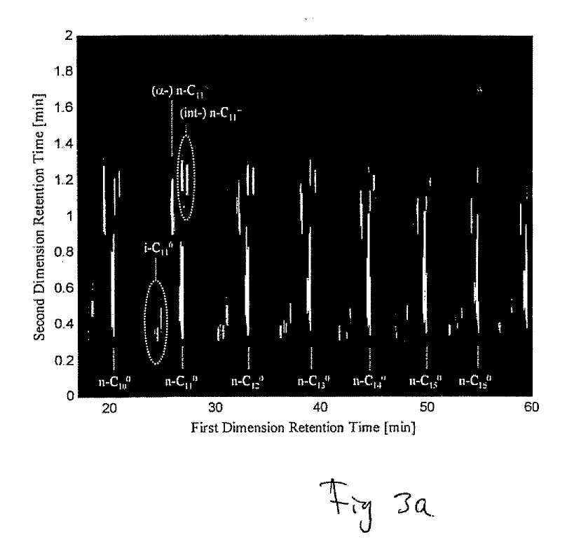

In FIG. 2 the GCxGC chromatograms are given. In FIG. 3 some characteristic regions of these chromatograms have been highlighted in more detail. The chromatogram of the feed in FIGS. 2a and 3a shows a nice separation of peaks. The n-paraffins (denoted as n-C_{X}⁰) of the feed are clearly separated from the i-paraffins (i-C_{X}⁰). These i-paraffins represent mono-methyl branched paraffins. The α-n-olefins (α-n-C_{X}=) and internal-n-olefins (α-int-C_{X}=) are located just above the n-paraffin peaks. The separation is even better than that for the simulated distillation, and even alcohols, Fischer-Tropsch Synthesis by-products, are observed at higher second dimension retention times.

The chromatograms of the product at 0.2 m (50 ms) in FIGS. 2b and 3b reveal the rapid formation of many components during this ‘initial time frame’. A high variety of different olefinic isomers are formed. The formation of i-olefins (i-C_{X}=) in the C₅-C₁₉ range is a characteristic feature. In the C₅-C₈ range large amounts of both n-olefins and i-olefins are present. This observation applies for a somewhat lesser extent to the C₉-C₁₁ fraction. Already at this short reactor length the first traces of mono-aromatics appear. The oxygenates have been fully converted.

With increasing reactor length the C₅-C₈ range becomes even more saturated with a wide variety of isomeric species. At 1.2 m the i-olefins, that were initially formed in the C₁₆-C₂₀ range, have already been converted. At 3.2 m also the i-olefins from the C₁₃-C₁₅ range have been converted. Clearly, the i-paraffins in the C₁₃-C₂₀ are less reactive than the i-olefins. With increasing length the amount of mono-aromatics become higher. At 21.2 m the largest n-paraffins have been converted completely and the formation of naphthenic and aromatic components is distinctly visible in the spectrum. The C₅-C₈ range contains a wide variety of paraffinic, olefinic, and naphthenic species. The tiles in this range display a relatively large overlap. The detailed results on the aromatics reveal the increase of size with the residence time.

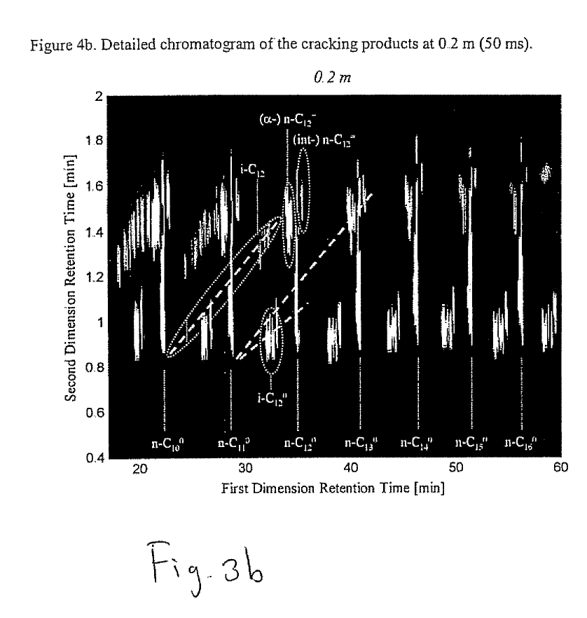

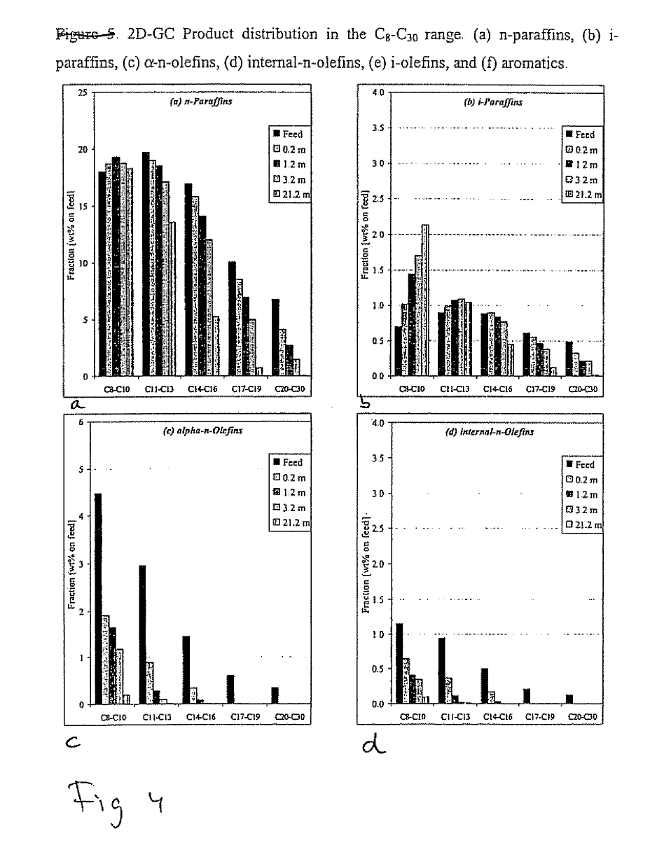

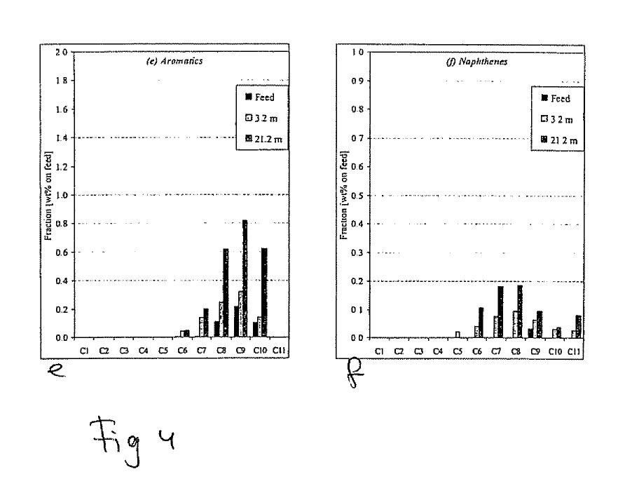

In FIG. 4 the quantitative results of the GCxGC analyses have been given. Due to the oversaturation in the C₅-C₈ range the species in this fraction could not be satisfactorily quantified. The data confirms that the reactivity of the n-paraffins increase with carbon number. A similar observation is made for the i-paraffins that show a lower reactivity than that for the n-paraffins; in agreement with these observations, only the i-paraffins larger than C₁₄ show net conversion over the whole reactor length. As already observed from the chromatograms the olefins are far more reactive than the paraffins. For the α-n-olefins and internal-n-olefins larger than C₈ a net conversion is observed over the whole reactor length, whereas the concentrations of i-olefins go through a maximum at 50 ms.

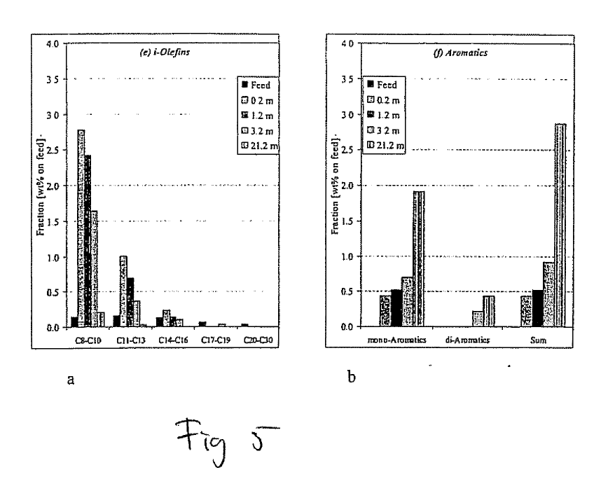

In FIG. 5 the profiles of the mono-aromatics and di-aromatics are shown. The ‘sum’ in this graph also includes naphthenic and naphthenic mono-aromatics.

In table 1 an overview of the calculated reaction rate constants (expressed in s-1) is given. Since i-olefins are initially formed at 50 ms and then converted the initial boundary has been set at this point and not at the feed conditions. It is obvious that for n-paraffins, i-paraffins, n-olefins, and i-olefins the reaction rate constants increase with increasing chain length. Overall, the n-paraffins have a higher reaction rate constant than the i-paraffins. The olefins are much more reactive than the paraffins. Also in this case the linear species appear to be more reactive than the branched species.

TABLE 1

| | | | n- | | | |
|---|---|---|---|---|---|---|
| | n- | i- | olefins | i- | α-n- | int-n- |
| | paraffins | paraffins | (1) | olefins | olefins | olefins |
| C₈-C₁₀ | 0.01 | n.d. (2) | 0.68 | 0.74 | 0.57 | 1.11 |
| C₁₁-C₁₃ | 0.08 | n.d. (2) | 4.91 | 1.57 | 4.50 | 5.44 |
| C₁₄-C₁₆ | 0.29 | 0.17 | 6.32 | 1.58 | 5.23 | 7.61 |
| C₁₇-C₁₉ | 0.81 | 0.44 | n.d. | n.d. | n.d. | n.d. |
| | | | (3) | (3) | (3) | (3) |
| C₂₀-C₃₀ | 1.70 | 0.81 | n.d. | n.d. | n.d. | n.d. |
| | | | (3) | (3) | (3) | (3) |

(1) sum of α-n-olefins and internal-n-olefins.
(2) not determined; species are formed on a net basis.
(3) not determined; data does not allow reliable estimation.

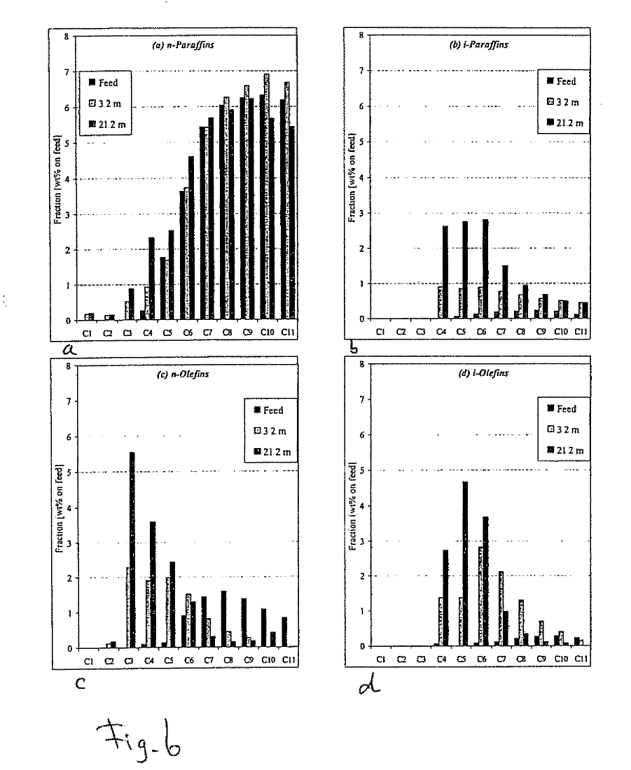

In FIG. 6 the quantitative data of the PIONA analyses has been given. The results have been combined with the detailed analysis of the gaseous product and, hence, give a detailed overview of the component profiles in the C₁-C₁₁ range. In agreement with the GCxGC data the n-paraffins do display net conversion for species larger than C₈, and over the whole reactor length the i-paraffins increase, mainly in the C₄-C₇ range. For the n-olefins mainly C₃-C₅ species are formed. The C₇ i-olefins display cracking activity; smaller species are formed in relatively high quantities and do not show net conversion. Aromatics and naphthenic species are solely formed and are present in relatively low quantities. The above illustrates that the combination of the GCxGC method according the invention and a Fischer-Tropsch wax as feedstock form an ideal combination to investigate the mechanism which occurs in a catalytic cracking process. The simulated distillation study already gives detailed information on the individual reactivities and product yields for the paraffins and olefins. The qualitative and quantitative results of the GCxGC analyses have demonstrated that in the conversion of the Fischer-Tropsch Light Fraction already at 0.2 m a complex product spectrum has evolved. During this ‘initial time-frame’ of 50 ms countless reactions and interactions between a wide variety of molecules take place. The catalytic conversion of the feed dominates, but parallel radical reactions are involved in coke formation. After 50 ms, during the ‘steady-state time-frame’ no more coke is formed and the conversion process is governed solely by catalytic reactions. This underlines that it is extremely difficult to translate catalytic cracking studies that involve model components to practical situations. The complexity of the product increases even further with increasing reactor length and especially the C₅-C₈ range becomes highly saturated with a large number of different components. In this range the PIONA analysis provides a more detailed overview. By combination of the data obtained from the analysis of the gaseous products a highly detailed overview of the full carbon range (C₁-C₃₀) can be obtained that is valuable for mechanistic and kinetic studies under realistic FCC conditions.

1. A method to measure the quantity of olefin species in a complex hydrocarbon mixture by means of comprehensive multi-dimensional gas chromatography, wherein the method comprises passing a sample of the hydrocarbon mixture through a first capillary column comprising a dimethyl-polysiloxane stationary phase; subjecting the sample to a thermal modulation; and passing the sample through a second column comprising a 50% phenyl, equivalent, polysilphenylene-siloxane stationary phase, wherein the introduction bandwidth into the second column is smaller than 20 milliseconds.

2. The method according to claim 1, wherein the introduction bandwidth into the second column is smaller than 15 milliseconds.

3. The method according to claim 1, wherein the thermal modulation comprises alternatingly cooling and heating a downstream part of the first column.

4. The method according to claim 1, wherein the length of the first column is between 5 and 50 m, the diameter of the first column is between 0.1 and 0.6 mm and the thickness of the stationary phase is between 0.05 and 3 μm.

5. The method according to claim 1, wherein the length of the second column is between 0.5 and 4 m, the diameter of the second column is between 0.08 and 0.6 mm and the thickness of the stationary phase is between 0.05 and 3 μm.

6. The method according to claim 1, wherein a phase ratio in the first and/or the second column is between 100 and 500, wherein the phase ratio is calculated by the following formula:
phase ratio=R/(2*Df),
wherein R is the radius of the column and Df is the thickness of the stationary phase.

7. The method according to claim 1, wherein the complex hydrocarbon mixture boils for more than 90 wt % between 100 and 575° C. and comprises more than 10 wt % of components which boil between 350 and 575° C.

8. The method according to claim 3, wherein the thermal modulation is performed by a dual stage modulator comprising a two-jet cryogenic modulator.

9. A method to make a kinetic model of a catalytic cracking reaction comprising subjecting a well defined feed to a catalytic cracking reaction at a well defined temperature and catalyst concentration, measuring the reactants at different catalyst contact times with the method according to claim 1, calculating kinetic constants for possible reactions; and obtaining a kinetic model.

10. A method of controlling a catalytic cracking process comprising using the kinetic model obtained in a process according to claim 9 to control the catalytic cracking process.

11. A method of controlling a chemical conversion process comprising using an analytical method according to claim 1 to measure the olefin content in a feed and/or product of a chemical conversion process and controlling said chemical conversion process using the measured olefin content.

12. A method of controlling a chemical conversion process according to claim 11, wherein the chemical conversion process is a hydroprocessing treatment of an olefin containing Fischer-Tropsch derived feed.
